(19) United States
(12) Patent Application Publication
(10) Pub. No.: US 2026/0229962 A1
(43) Pub. Date: Aug. 6, 2026

(54) ELECTRIC MOTOR WITH CONFORMAL COOLING CHANNEL

(71) Applicant: GM Global Technology Operations LLC, Detroit, MI (US)

(72) Inventors: Derek Frei Lahr, Ann Arbor, MI (US); Alireza Fatemi, Canton, MI (US); Peng Peng, Rochester Hills, MI (US); Xiaofeng Yang, Troy, MI (US); Diptak Bhattacharya, Royal Oak, MI (US)

(73) Assignee: GM Global Technology Operations LLC, Detroit, MI (US)

(21) Appl. No.: 19/046,586

(22) Filed: Feb. 6, 2025

(51) Int. Cl. H02K 9/22; H02K 9/19

(52) U.S. Cl. CPC H02K 9/227; H02K 9/19

(57) ABSTRACT

An electric motor including a motor housing extending along a longitudinal axis, a stator coupled to the motor housing, a gap arranged radially between the motor housing and the stator, and at least one conformal cooling pouch arranged between the motor housing and the stator and including a fluid conduit extending between a first end and a second end.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to electric motors and, more particularly, to a thermal management system for electric motors.

Electric motors have become a pivotal component in the automotive industry, particularly with the rise of electric vehicles (EVs). These motors typically consist of two main parts: a rotor and a stator. The rotor is the rotating part of the motor, which is connected to the vehicle's drivetrain, while the stator is the stationary part that surrounds the rotor and contains the motor's windings. When electric current flows through the windings of the stator, it creates a magnetic field that interacts with the magnetic field of the rotor, causing it to turn and generate mechanical power.

Various methods of cooling electric motors have been developed and include liquid cooling, air cooling, and the use of heat sinks. Liquid cooling involves circulating a coolant through channels in the stator to absorb and dissipate heat. Air cooling, on the other hand, uses fans or natural convection to remove heat from the stator surface. Heat sinks, typically made of materials with high thermal conductivity, are attached to the stator to enhance heat dissipation. Shortcomings of existing systems and methods will be addressed by one or more aspects of the present disclosure.

### SUMMARY

In one configuration, an electric motor is provided and includes a motor housing extending along a longitudinal axis, a stator coupled to the motor housing, a rotor arranged within the stator and movable with respect to the longitudinal axis, and a conformal cooling pouch arranged between the motor housing and the stator. The conformal cooling pouch including a first end, a second end spaced from the first end, a first layer extending between the first end and the second end, a second layer coupled to the first layer, and a fluid conduit arranged between the first layer and the second layer and directly contacting a portion of the stator and the motor housing.

The electric motor may include one or more of the following optional aspects. For example, the stator can include an inner wall and an outer wall spaced from the inner wall. The electric motor can include a gap arranged between the motor housing and the outer wall of the stator. The conformal cooling pouch can occupy a majority of the gap and the fluid conduit can directly contact the outer wall of the stator and the motor housing.

According to at least one aspect, the stator can include one or more mounting ears coupled to the outer wall and spaced circumferentially with respect to the longitudinal axis. The conformal cooling pouch can include one or more openings that correspond with the one or more mounting ears.

According to another aspect, the fluid conduit can include an inlet and an outlet arranged at the same end of the conformal cooling pouch. The fluid conduit can include a serpentine path between the inlet and the outlet.

According to at least one example, the fluid conduit can include an inlet and an outlet arranged at opposite ends of the conformal cooling pouch. The fluid conduit can include a serpentine path between the inlet and the outlet.

According to another example, the fluid conduit can include a first fluid conduit and a second fluid conduit, the first fluid conduit and the second fluid conduit can be arranged parallel to one another.

In another configuration, an electric motor is provided and includes a motor housing extending along a longitudinal axis, a stator coupled to the motor housing, a gap arranged radially between the motor housing and the stator, and at least one conformal cooling pouch arranged between the motor housing and the stator and including a fluid conduit extending between a first end and a second end.

The electric motor may include one or more of the following optional aspects. For example, the at least one conformal cooling pouch may include a first conformal cooling pouch and a second conformal cooling pouch spaced circumferentially from the first conformal cooling pouch.

According to at least one aspect, the fluid conduit may directly contact the stator and the motor housing. The fluid conduit may include a water-glycol fluid between the first end and the second end.

In another configuration, a vehicle is provided and includes a vehicle body extending between a first end and a second end, a power reservoir coupled to the vehicle body, and an electric motor coupled to the vehicle body and communicatively coupled to the power reservoir. The electric motor includes a motor housing extending along a longitudinal axis, a stator coupled to the motor housing, a rotor arranged within the stator and movable with respect to the longitudinal axis, a gap arranged radially between the motor housing and the stator, and a conformal cooling pouch arranged in the gap between the motor housing and the stator. The conformal cooling pouch includes a fluid conduit extending between a first end and a second end and directly contacting a portion of the motor housing and a portion of the stator.

The vehicle may include one or more of the following optional aspects. For example, the fluid conduit may include a first fluid conduit and a second fluid conduit. The first fluid conduit and the second fluid conduit may be arranged in parallel to each other.

According to at least one aspect, the fluid conduit may include a serpentine pattern between the first end and the second end.

According to another aspect, the conformal cooling pouch may consume almost all of the gap.

According to at least one example, the fluid conduit may directly contact the stator and the motor housing.

### BRIEF DESCRIPTION OF THE DRAWINGS

The drawings described herein are for illustrative purposes only of selected configurations and are not intended to limit the scope of the present disclosure.

FIG. 1 is a front perspective view a vehicle including a power reservoir and a motor according to principles of the present disclosure;

FIG. 2 is an end view of the motor of FIG. 1;

FIG. 3 is a side view of the motor of FIG. 2 with a motor housing removed;

FIG. 4A is a perspective view of a conformal cooling pouch according to the principles of the present disclosure;

FIG. 4B is another perspective view of the conformal cooling pouch according to the principles of the present disclosure;

FIG. 5 is a front view of one configuration of a conformal cooling pouch according to the principles of the present disclosure;

FIG. 6 is a front view of conformal cooling pouches according to the principles of the present disclosure;

FIG. 7 is a front view of another conformal cooling pouch according to principles of the present disclosure; and

FIG. 8 is a front view of another conformal cooling pouch according to principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

High performance induction motors, as well as other types of motors, require stator currents that produce more losses. Managing these losses can be desirable to prevent overheating during operation. Oil cooling is commonly used as it can efficiently cool windings and other aspects of the motor. At least some of the principles of the present disclosure provide another method and apparatus that can be desirable for cooling motors during and after operation.

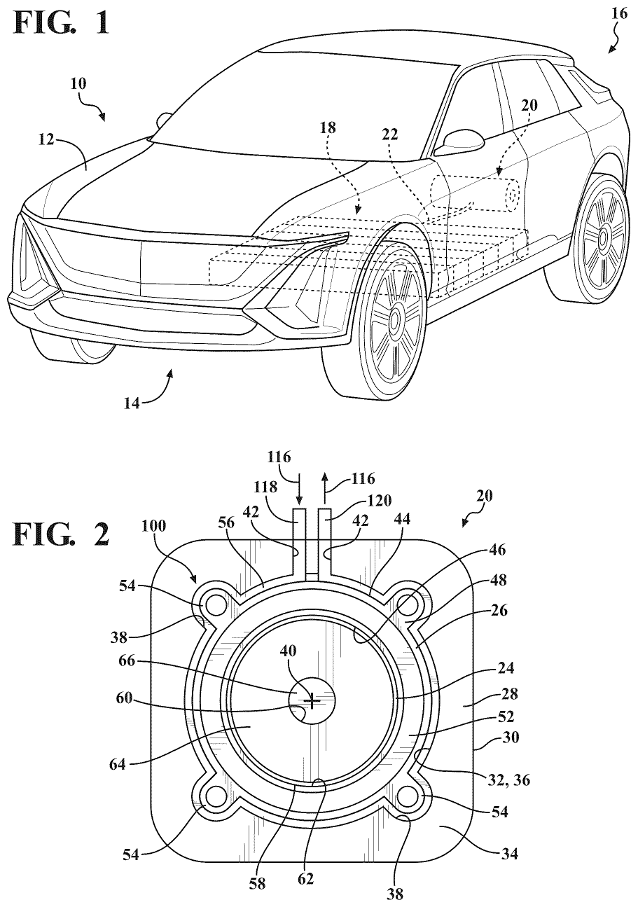

With reference to FIG. 1, an illustrative example of a vehicle 10 is provided. The vehicle 10 has a vehicle body 12 extending between a first end 14 and a second end 16. The vehicle 10 includes a power reservoir (e.g., battery pack) 18 coupled to the vehicle body 12. The power reservoir 18 is communicatively coupled to an electric motor (i.e., motor) 20 via a cable 22.

With reference to FIG. 2, the motor 20 includes a rotor 24 that is movable with respect to a stator 26. The motor 20 also includes a motor housing 28 that receives the rotor 24, the stator 26, and a conformal cooling pouch (hereinafter, cooling pouch) 100 that is configured to remove heat from the stator 26 and other components of the motor 20 during and after operation. The motor housing 28 includes an outer wall 30 and an inner wall 32 spaced radially from the outer wall 30. With reference to FIG. 2, the outer and inner walls 30, 32 extend between a first end 34 and a second end that is positioned into the page and opposite of the first end 34. The inner wall 32 defines a chamber 36 and can include one or more grooves or channels 38 that correspond with a portion of the stator 26. In the present illustrative example, the channels 38 are spaced circumferentially with respect to a longitudinal axis that extends through the motor 20 and into the page at 40. The motor housing 28 can also include one or more openings 42 that correspond with a portion of the cooling pouch 100 so that a fluid can flow toward and away from the motor 20, for example.

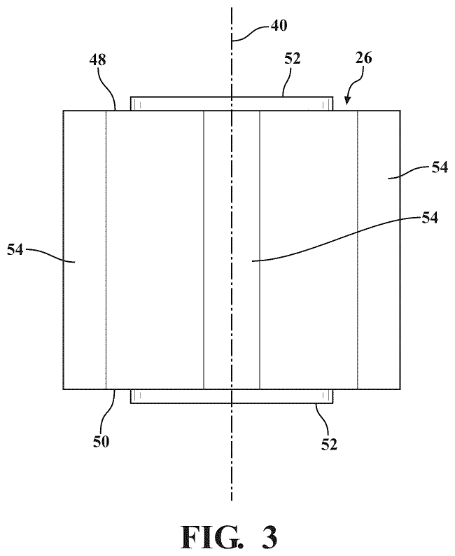

The stator 26 includes an outer wall 44 and an inner wall 46 spaced from the outer wall 44, as shown in FIG. 2. With reference to FIG. 3, the stator 26 includes a first end 48 arranged adjacent to the first end 34 of the motor housing 28 and a second end 50 arranged adjacent to the second end of the motor housing 28. End turns or coil heads 52 can be positioned at or extend from the first end 48 and/or the second end 50 of the stator 26. With reference to FIGS. 2 and 3, one or more attachments or mounting ears 54 can be coupled to or otherwise attached to the outer wall 44 and are spaced circumferentially with respect to the longitudinal axis 40. The mounting ears 54 can be configured to correspond with the channels 38 so that the stator 26 can be positioned within the chamber 36 and coupled to the motor housing 28. Upon assembly, the motor 20 can include a gap 56 that is arranged between the outer wall 44 of the stator 26 and the inner wall 32 of the motor housing 28.

The rotor 24 includes an outer wall 58 and an inner wall 60 spaced from the outer wall 58, as shown in FIG. 2. The rotor 24 includes a first end 62 and a second end that is positioned into the page and opposite of the first end 62. The first end 62 of the rotor 24 can be positioned at or adjacent to the first end 34 of the motor housing 28 and the first end 48 of the stator 26. Likewise, the second end of the rotor 24 can be positioned at or adjacent to the second end of the motor housing 28 and the second end 50 of the stator 26. End turns or coil heads 64 can be arranged at or extend from the first end 62 or second end of the rotor 24. A shaft 66 can be coupled the rotor 24 and extend along the longitudinal axis 40.

With continued reference to FIG. 2, the cooling pouch 100 can be arranged in the motor 20 and can be configured to remove heat from the stator 26 and/or the motor housing 28 during or after operation, for example. More particularly, the cooling pouch 100 can be arranged in the gap 56 and directly contact one or both the stator 26 and the motor housing 28.

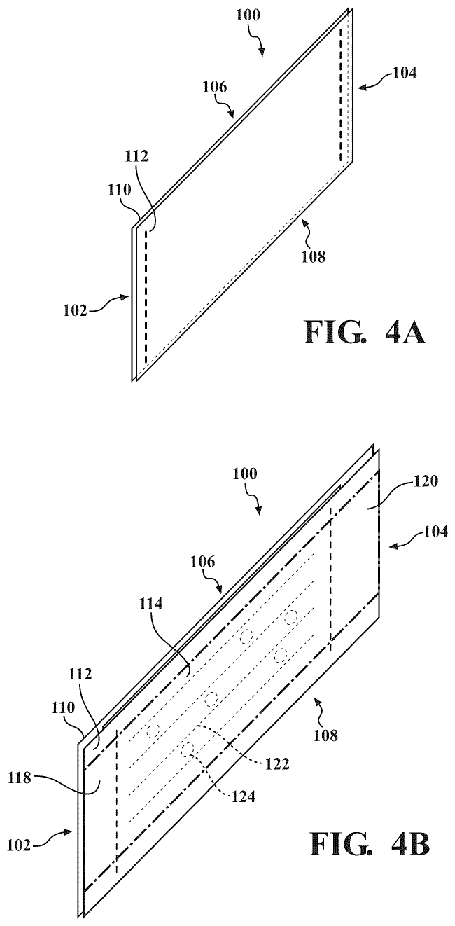

With reference to FIG. 4A, the cooling pouch 100 can include a first or left end 102 and a second or right end 104 spaced from the first end 102 and a first or upper side 106 and second or lower side 108 spaced from the upper side 106. The cooling pouch 100 can include a first layer or sheet 110 that extends between the first end 102 and the second end 104 and between the upper side 106 and the lower side 108. The cooling pouch 100 can include a second layer or sheet 112 that is selectively coupled to the first layer 110. According to one aspect, the first and second layers 110, 112 can be made of aluminum laminates, steel laminates, polypropylene laminates, or another material commonly used in the automotive industry.

In the present illustrative example, the second layer 112 can be coupled to the first layer 110 to define a fluid conduit 114 that extends between and is configured to carry a fluid 116 between the first end 102 and the second end 104. According to one aspect, with reference to FIGS. 4A and 4B, the second layer 112 can be coupled to or otherwise attached (e.g., heat sealed) to the first layer 110 to define an inlet 118, an outlet 120, and one or more fluid channels 122 between the inlet 118 and the outlet 120. Optionally, with reference to FIG. 4B, the second layer 112 can be coupled to or otherwise attached to the first layer 110 to form one or more nodules 124 that are configured to induce turbulence within the fluid conduit 114 to enhance heat transfer and/or structural integrity of the cooling pouch 100, for example. According to another aspect, the fluid 116 can be a coolant, a phase change material, or another material (e.g., an oil, a water-glycol mixture, a two-phase coolant or refrigerant, etc.) that can effectively remove heat from the motor 20 during or after operation.

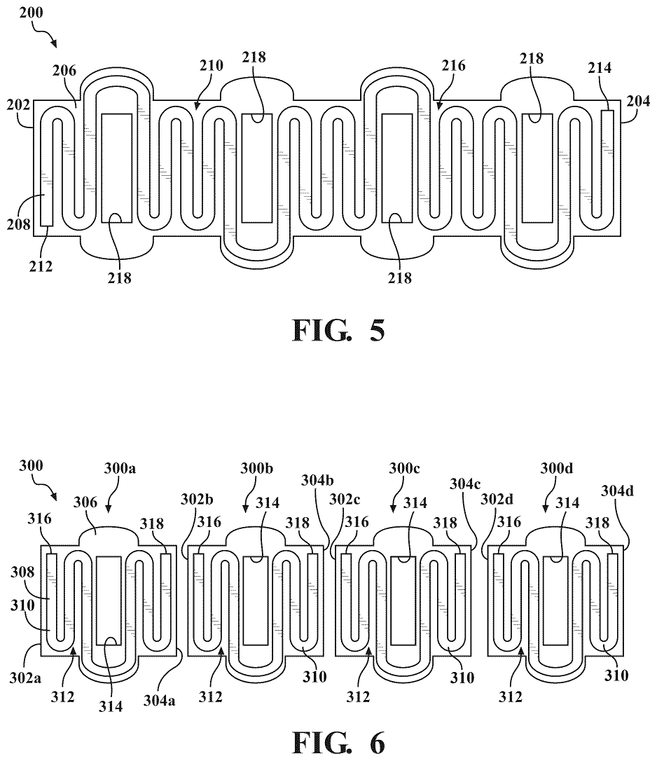

FIG. 5 illustrates another illustrative configuration of a conformal cooling pouch (i.e., cooling pouch) 200. This configuration is similar in many respects to the configuration of FIGS. 1-4B. Accordingly, the descriptions of the configurations are hereby incorporated into one another, and description of subject matter common to the configurations generally may not be repeated.

With reference to FIG. 5, the cooling pouch 200 includes a first end 202 and a second end 204 spaced from the first end 202. In the present illustrative example, the pouch 200 has a first layer 206 and a second layer 208 coupled or otherwise attached to the first layer 206. According to one aspect, the second layer 208 can be heat sealed to the first layer 206 to define a fluid conduit 210 configured to carry a fluid (not shown). The fluid conduit 210 includes an inlet 212 arranged at the first end 202 and an outlet 214 arranged at the second end 204. In other words, the inlet 212 and the outlet 214 are arranged at opposite ends of the cooling pouch 200. According to another aspect, the fluid conduit 210 can include a serpentine pattern 216 between the first end 202 and the second end 204. Additionally, the cooling pouch 200 can include one or more openings 218 that extend through the first and/or second layers 206, 208 to accommodate a portion of the stator 26 (FIGS. 2 and 3). For instance, the openings 218 can be configured to receive a portion of the mounting ears 54 so that a majority of the fluid conduit 210 can contact the outer wall 58 (FIG. 3) of the stator 26. In the present illustrative configuration, the fluid conduit 210 extends between the openings 218 and above and below the openings 218. This can be desirable to enhance (i.e., maximize) heat transfer between the stator 26 and the cooling pouch 200, for example.

FIG. 6 illustrates another illustrative configuration of a conformal cooling pouch (i.e., cooling pouch) 300. This configuration is similar in many respects to the configurations of FIGS. 1-4B and FIG. 5. Accordingly, the descriptions of the configurations are hereby incorporated into one another, and description of subject matter common to the configurations generally may not be repeated.

With reference to FIG. 6, the cooling pouch 300 includes one or more segments 300a, 300b, 300c, 300d. The segments 300a-d are configured to be individually arranged within the motor 20 (FIGS. 2 and 3) and remove heat from the stator 26 and/or the motor housing 28 during and after operation. In the present illustrative example, the segments include a first segment 300a, a second segment 300b, a third segment 300c, and a fourth segment 300d. Note, the principles of the present disclosure equally apply to configurations that include two, three, or n-number number of segments.

In the present illustrative configuration, the segments 300a-d each include a first end 302a-d and a second end 304a-d spaced from the first end 302a-d. In assembly, the individual segments 300a-d can be formed on the outer wall 30 of the stator 26 or arranged (i.e., positioned, inserted, etc.) within the gap 56 between the stator 26 and the motor housing 28. In other words, the segments 300a-d can be positioned circumferentially on the outer wall 44 of the stator 26 and can be configured to expand (i.e., inflate) to fill the gap 56. In the present illustrative configuration, a first end 302a of the first segment 300a can be arranged adjacent to or contact a second end 304d of the fourth segment 300d. A second end 304a of the first segment 300a can be arranged adjacent to or directly contact a first end 302b of the second segment 300b. A second end 304b of the second segment 300b can be arranged adjacent to or directly contact a first end 302c of the third segment 300c. A second end 304c of the third segment 300c can be arranged adjacent to or directly contact a first end 302d of the fourth segment 300d.

The segments 300a-d can each include a first layer 306 and a second layer 308 selectively coupled to or otherwise attached to the first layer 306. The first layer 306 and the second layer 308 can define a fluid conduit 310 that forms a serpentine pattern 312 or another pattern. In the present illustrative example, the fluid conduits 310 are arranged in the same pattern on each of the segments 300a-d, however, the segments 300a-d can each have a different pattern from one another to enhance (i.e., maximize) heat transfer, for example. Each of the segments 300a-d can include one or more openings 314 that accommodate a portion of the stator 26, such as the mounting ears 54. The fluid conduit 310 can be arranged on either side of the one or more openings 314 and/or above or below the openings 314, as shown in FIG. 6. Each of the fluid conduits 310 can be configured to carry a fluid between an inlet 316 and an outlet 318 spaced from the inlet 316. According to one aspect, the fluid used in each fluid conduit 310 of the segments 300a-d can be the same fluid or a different fluid.

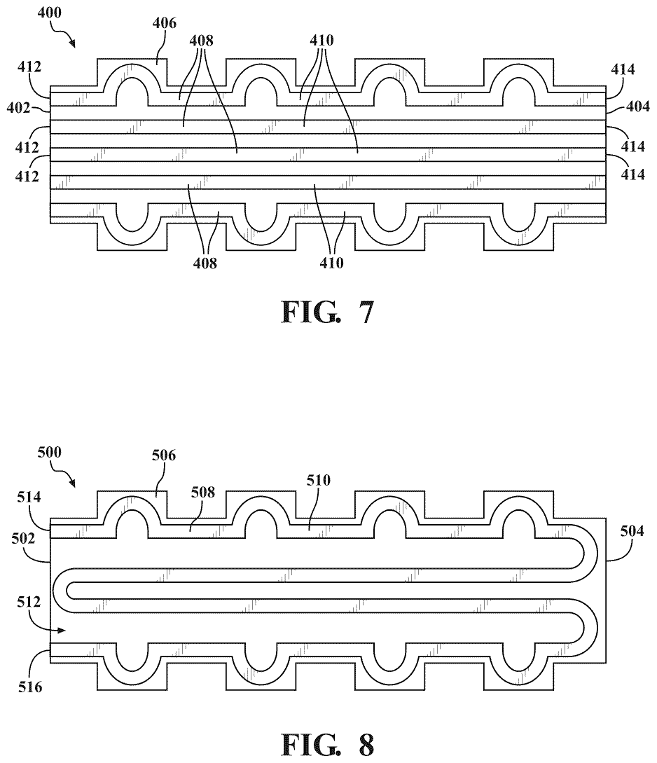

FIG. 7 illustrates another illustrative configuration of a conformal cooling pouch (i.e., cooling pouch) 400. This configuration is similar in many respects to the configurations of FIGS. 1-4B, FIG. 5, and FIG. 6. Accordingly, the descriptions of the configurations are hereby incorporated into one another, and description of subject matter common to the configurations generally may not be repeated.

With reference to FIG. 7, the cooling pouch 400 includes a first end 402 and a second end 404 spaced from the first end 402. The cooling pouch 400 includes one or more first layers 406 and one or more second layers 408 selectively coupled to or otherwise attached to the first layers 406. The first layers 406 and the second layers 408 can be arranged to define one or more fluid conduits 410 that extend between the first end 402 and the second end 404. In the present illustrative configuration, the cooling pouch 400 includes several fluid conduits 410 that are independent of one another, and each defines an inlet 412 and an outlet 414. According to one aspect, at least two of the fluid conduits 410 are arranged parallel to one another between the first end 402 and the second end 404.

FIG. 8 illustrates another illustrative configuration of a conformal cooling pouch (i.e., cooling pouch) 500. This configuration is similar in many respects to the configurations of FIGS. 1-4B, FIG. 5, FIG. 6, and FIG. 7. Accordingly, the descriptions of the configurations are hereby incorporated into one another, and description of subject matter common to the configurations generally may not be repeated.

With reference to FIG. 8, the cooling pouch 500 includes a first end 502 and a second end 504 spaced from the first end 502. The cooling pouch 500 includes a first layer 506 and a second layer 508 selectively coupled to or otherwise attached to the first layer 506. The first layer 506 and the second layer 508 define a fluid conduit 510 that extends between the first end 502 and the second end 504. According to one aspect, the fluid conduit 510 can be arranged in a serpentine pattern 512 or another pattern between an inlet 514 and an outlet 516. In the present illustrative example, the inlet 514 and the outlet 516 are arranged on the same side of the cooling pouch 500.

In addition to the foregoing, the motor can include a pressure regulation and flow mechanism that is configured to control pressure and/or flow rate of the fluid within the cooling pouches. According to one aspect, regularly circulating the fluid along the fluid conduits can avoid stagnant fluid and improve cooling efficiency. According to another aspect, the pressure regulation and flow mechanism can be configured to dynamically adjust the pressure and/or flow during operation to accommodate scenarios where more heat is generated.

Any of the foregoing configurations of the cooling pouches can be retrofitted to existing motors. As indicated above the cooling pouches can be arranged on the stator prior to being assembled in a motor. In either scenario, the fluid conduits of the cooling pouches can be arranged to fill all or almost all of the space between the stator and the motor housing to maximize thermal efficiency during and after operation of the motor.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. An electric motor, comprising:
a motor housing extending along a longitudinal axis;
a stator coupled to the motor housing;
a rotor arranged within the stator and movable with respect to the longitudinal axis; and
a conformal cooling pouch arranged between the motor housing and the stator, comprising:
a first end,
a second end spaced from the first end,
a first layer extending between the first end and the second end,
a second layer coupled to the first layer, and
a fluid conduit arranged between the first layer and the second layer and directly contacting a portion of the stator and the motor housing.

2. The electric motor of claim 1, wherein the stator includes an inner wall and an outer wall spaced from the inner wall.

3. The electric motor of claim 2, further comprising a gap arranged between the motor housing and the outer wall of the stator.

4. The electric motor of claim 3, wherein the conformal cooling pouch occupies a majority of the gap and the fluid conduit directly contacts the outer wall of the stator and the motor housing.

5. The electric motor of claim 2, wherein the stator includes one or more mounting ears coupled to the outer wall and spaced circumferentially with respect to the longitudinal axis.

6. The electric motor of claim 5, wherein the conformal cooling pouch includes one or more openings that correspond with the one or more mounting ears.

7. The electric motor of claim 1, wherein the fluid conduit includes an inlet and an outlet arranged at the same end of the conformal cooling pouch.

8. The electric motor of claim 7, wherein the fluid conduit includes a serpentine path between the inlet and the outlet.

9. The electric motor of claim 1, wherein the fluid conduit includes an inlet and an outlet arranged at opposite ends of the conformal cooling pouch.

10. The electric motor of claim 9, wherein the fluid conduit includes a serpentine path between the inlet and the outlet.

11. The electric motor of claim 1, wherein the fluid conduit includes a first fluid conduit and a second fluid conduit, the first fluid conduit and the second fluid conduit are arranged parallel to one another.

12. An electric motor, comprising:
a motor housing extending along a longitudinal axis;
a stator coupled to the motor housing;
a gap arranged radially between the motor housing and the stator; and
at least one conformal cooling pouch arranged between the motor housing and the stator and including a fluid conduit extending between a first end and a second end.

13. The electric motor of claim 12, wherein the at least one conformal cooling pouch includes a first conformal cooling pouch and a second conformal cooling pouch spaced circumferentially from the first conformal cooling pouch.

14. The electric motor of claim 12, wherein the fluid conduit directly contacts the stator and the motor housing.

15. The electric motor of claim 14, wherein the fluid conduit includes a water-glycol fluid between the first end and the second end.

16. A vehicle, comprising:
a vehicle body extending between a first end and a second end;
a power reservoir coupled to the vehicle body; and
an electric motor coupled to the vehicle body and communicatively coupled to the power reservoir, the electric motor comprising:
a motor housing extending along a longitudinal axis,
a stator coupled to the motor housing,
a rotor arranged within the stator and movable with respect to the longitudinal axis,
a gap arranged radially between the motor housing and the stator, and
a conformal cooling pouch arranged in the gap between the motor housing and the stator, the conformal cooling pouch including a fluid conduit extending between a first end and a second end and directly contacting a portion of the motor housing and portion of the stator.

17. The vehicle of claim 16, wherein the fluid conduit includes a first fluid conduit and a second fluid conduit, the first fluid conduit and the second fluid conduit being arranged in parallel to each other.

18. The vehicle of claim 16, wherein the fluid conduit includes a serpentine pattern between the first end and the second end.

19. The vehicle of claim 16, wherein the conformal cooling pouch consumes almost all of the gap.

20. The vehicle of claim 16, wherein the fluid conduit directly contacts the stator and the motor housing.
